(19) United States
(12) Patent Application Publication
(10) Pub. No.: US 2019/0219082 A1
(43) Pub. Date: Jul. 18, 2019

(54) FASTENER ASSEMBLY

(71) Applicant: BLUESKY SOLUTIONS LIMITED, Lutterworth Leichestershire (GB)

(72) Inventors: Paul Marks, Horsham West Sussex (GB); Paul Cummings, Fritwell Oxfordshire (GB); Charles Van Blerk, Ripon North Yorkshire (GB); James Samuel, Poole Dorset (GB); Bruce Renfrew, Leicester Leicestershire (GB); Shaun Phillips, Peterborought Cambridgeshire (GB); Hugo Swift, St Albans Hertfordshire (GB)

(73) Assignee: BLUESKY SOLUTIONS LIMITED, Lutterworth Leichestershire (GB)

(21) Appl. No.: 16/327,778

(22) PCT Filed: Aug. 24, 2017
(86) PCT No.: PCT/GB2017/052492

§ 371 Date: Feb. 22, 2019

(30) Foreign Application Priority Data
Aug. 24, 2016 (GB) 1614437.0
Jul. 31, 2017 (GB) 1712319.1

(51) Int. Cl. F16B 7/04; F16B 45/06

(52) U.S. Cl. CPC F16B 7/0473; F16B 45/06

(57) ABSTRACT

The present invention provides a fastener assembly (20) for a prefabricated service module. The fastener assembly (20) comprises a first arm (21) having a flange (211) at a first end (221) thereof; a second arm (22) having a flange (221) at a first end (222) thereof; and a retainer mechanism (23). The second arm (22) is arranged parallel and opposite to the first arm (21); and the flanges (211, 221) of the first and second arms (21, 22) are arranged opposite from one another and extend in a direction away from each other. The first end (212) of the first arm (21) is moveable between a first position wherein said first end (212) is spaced apart from the first end (222) of the second arm (22) at a first distance, and a second position wherein said first end (212) is spaced apart from the first end (222) of the second arm (21) at a second distance, the first distance being greater than the second distance. The retainer mechanism (23) is configured to releasably hold the first end (212) of the first arm (21) in the second position.

### FIELD OF THE INVENTION

The present invention relates to a fastener assembly in particular but not necessarily for facilitating the positioning and/or installation of suspended objects such as ducting, integrated service modules, prefabricated modules etc. during construction of buildings.

### BACKGROUND OF THE INVENTION

Building construction sites for large buildings frequently employ construction equipment for lifting large and heavy components into position during the construction of a building.

An example large and heavy components lifted during construction of a building is overhead ducting. The lengths of standard ducting may be up to 2.9 meters in length and up to 2.1 meters×2.5 meters in section and weigh up to 350 kgs.

Another example of such a component is a prefabricated service module such as an integrated service module. An integrated service module is a form of factory assembled modular chilled beam that incorporates other services in addition to cooling.

Because such service modules are fabricated off site, they tend to produce less waste, have a better build quality, have fewer defects and are faster to install. They are also beneficial in that less storage is generally needed on site than in cases where the different components contained in the service module are provided separately.

Furthermore, the different components contained in the module can be delivered to site pre-tested and ready to ‘plug and play’.

Because prefabricated service modules can be selected from a range of standard modules or be custom designed to suit particular needs, many building service systems are now installed using prefabricated modules.

The various components i.e. pipe-work, ducts, cable trays etc., forming the service module are installed in a support frame and the choice of components would depend on requirements/application of the construction project.

On site, the ducting/support frame of the prefabricated module is hoisted or lifted into position and fixed to or suspended from a supporting surface in its desired location i.e. within a roof space. In some cases, the module is installed flush with a suspended ceiling.

Once installed, a fitter will complete the installation by connecting the services one module to the next prior to the final fix (cabling, communications etc.).

The overhead ducting/prefabricated service modules are suspended from its supporting surface by means of suitable suspension means such as a support rod in the form of hanging or threaded rod; a suspension cable or the like.

The support rod is generally provided with an eyebolt, while the suspension cable with an eye-loop through with the overhead ducting/prefabricated service module may be connected thereto by means of suitable connection means such as a nut and bolt arrangement.

The aperture in the eyebolt/eye-loop needs to be aligned with a corresponding aperture in a bracket—for example a suspension ring, suspension brace etc., provided on/with the overhead ducting/prefabricated service module.

The modules are not that easy to handle, especially when the service runs are to be installed in the roof space of a narrow corridor, access to which might be by a less than generous doorway.

Furthermore, aerial lifts which are commonly used to lift the service module need to be located as close to the erection site as is possible for the safe lifting and manoeuvring of heavy loads, and generally are stabilised by means of stabilisers located at the corners of the self-drive body. In some circumstances due to ground works, or the state of the ground it may not be possible to position the aerial lift platform at an appropriate working distance from the work location and the aerial lift may be destabilised if material loads are supported at excess distances beyond the lift platform.

Precise alignment of the apertures can be quite time consuming and difficult, especially in situations where it is not possible to position the aerial lift platform at an appropriate working distance from the work location or in areas with tight working spaces.

This is further compounded by the need to have adequate access to the apertures to connect the components together by the nut and bolts or suitable connection means.

The present applicants have previously described a duct carrying apparatus for an aerial lift (GB2483465) which facilitates the lifting of overhead ducting during construction and the final positioning of the ducting.

The present inventions an improved fastener assembly which facilitates the positioning and fixing of overhead ducting, prefabricated service modules or the like.

### SUMMARY OF THE INVENTION

According to a first aspect, there is provided a fastener assembly for a prefabricated service module comprising:

a first arm having a flange at a first end thereof;

a second arm having a flange at a first end thereof, the second arm arranged parallel and opposite to the first arm; and

a retainer mechanism,

the flanges of the first and second arms are arranged opposite from one another and extend in a direction away from each other,

the first end of the first arm is moveable between a first position wherein said first end is spaced apart from the first end of the second arm at a first distance, and a second position wherein said first end is spaced apart from the first end of the second arm at a second distance, the first distance being greater than the second distance;

the retainer mechanism configured to releasably hold the first end of the first arm in the second position.

The fastener assembly in accordance with the invention provides a means for suspending a prefabricated module from a support surface without the need for threaded studs as used in the art. The fastener assembly allows for precise fixing of a service module to the support surface in a manner that is less time consuming and difficult than known methods.

In exemplary embodiments, the first end of the second arm is also moveable between a first position wherein said first end is at said first distance from the first end of the first arm, and a second position wherein said first end is at said second distance from the first end of the first arm.

Conveniently, the first end of the first arm and/or the first end of the second arm is biased towards the first position.

Preferably, the first distance is greater than 14 mm. In exemplary embodiments, the first distance is between 15 mm and 22 mm.

Preferably, the second distance is between 0 mm and 10 mm.

Preferably, the flange of the first arm and/or second arm has a width of between 2 mm and 8 mm.

In exemplary configurations, the first arm and/or second arm is a flat plate.

The flange of the first arm and/or the flange of the second arm may be straight. Alternatively, the flange of the first arm and/or the flange of the second arm may be curved or may define a hook.

In exemplary configurations, the retainer mechanism comprises a rod and two spaced apart beads mounted on the rod, and the first and second arms each comprise a slot thereon proximate the first ends thereof for receiving the retainer mechanism.

Preferably, the slots taper in a direction towards the first ends of the first and second arms, the width of the slots proximate the first ends of the first and second arms being slightly greater than a diameter of the rod and the maximum width of the slots being less than the diameter of the beads.

Preferably the slots are pear shaped.

In alternative exemplary configurations, the retainer mechanism comprises a rod and two spaced apart funnel shaped sections mounted on the rod, and the first and second arms each comprise a slot thereon proximate the first ends thereof for receiving the retainer mechanism.

Preferably the slots are in the form of an elongated channel and taper in a direction towards the first ends of the first and second arms, the width of the slots proximate the first ends of the first and second arms being slightly greater than a diameter of the rod and the maximum width of the slots being greater than the maximum diameter of the funnel shaped sections.

In yet alternative configurations, the retainer mechanism comprises a clip.

Preferably, the clip is flexible and made from a deformable material.

Preferably, the clip is resiliently deformable.

The clip preferably comprises a substantially V-shaped body, and an inwardly extending tab at each end of the V-shaped body, the tabs configured to engage with a respective flange of the first and second arms.

In further alternative configurations, the retainer mechanism comprises a rod and a stopper mounted on an end of the rod, and the first and second arms each comprise a slot thereon proximate the first ends thereof for receiving the retainer mechanism. The stopper may be any suitable shape.

Preferably, the slot on the second arm comprises two sections of variable width, a first slot section proximate the first end of the second arm and a second slot section downstream of the first slot section, wherein a width of the first slot section is less than a width of the stopper and configure to receive the rod in a snap fit or tightly therein, and a width of the second slot section is less than said width of the stopper and configured to receive the rod loosely therein.

According to a second aspect, there is provided a fastener assembly for a prefabricated service module comprising:

a first arm having a flange at a first end thereof;

a second arm having a flange at a first end thereof; and

a guide mechanism,

the flanges of the first and second arms are arranged opposite from one another and face away from each other,

the first end of the first arm is moveable between a first position wherein said first end is spaced apart from the first end of the second arm at a first distance, and a second position wherein said first end is spaced apart from the first end of the second arm at a second distance, the first distance being greater than the second distance;

the guide mechanism configured to facilitate movement of the first end of the first arm towards the second position.

Preferably, the guide mechanism comprises a first guide plate coupled to the flange of the first arm and a second guide plate coupled to the flange of the second arm.

The first and second guide plates may be integrally formed with a respective flange.

Preferably, the guide plates are positioned adjacent a respective flange and extend in a direction opposite to the direction of the respective flange.

Preferably, the guide plates are located on opposing ends of the flanges and configured cross one another as the first ends of the first and second arms move towards the second position.

In exemplary configurations of a fastener assembly according to a first aspect or second aspect of the invention, a second end of the first arm is connected to a second end of the second arm.

Preferably, the second end of the first arm is connected to the second end of the second arm by a connecting plate. This may be accomplished in any suitable way, for example, the first arm and second arm are integrally formed with the connecting plate.

The fastener assembly may further comprise a threaded stud depending from the connecting plate.

In embodiments having a threaded stud, the fastener assembly preferably further comprises a frame section configured to facilitate the coupling of the fastener assembly to a side member of a support frame of a service module.

Preferably, the frame section comprises a base section, a front section extending upwardly from the base section, and a flange section extending in the same direction as the front section from an opposite edge of the base section.

In exemplary embodiments, the frame section is mounted on the threaded stud such that a portion of said threaded stud is located between the front section and the flange section of the frame section.

Preferably, the threaded stud is positioned centrally on the base section.

According to a third aspect, there is provided a prefabricated service module comprising a fastener assembly according to a first and/or second aspect.

According to a fourth aspect, there is provided method of installing a prefabricated service module to a support surface, said method comprising the steps:

installing a plurality of framing struts to a support surface at a distance away from each other,

providing a prefabricated service module according to a third aspect,

connecting the fastener assembly of the prefabricated service module to the plurality of framing struts.

Other aspects are as set out in the claims herein.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 shows an example of a prefabricated service module as known in the art;

FIG. 2 shows an embodiment of a prefabricated service module in accordance with an aspect of the invention;

FIG. 3 shows a first embodiment of a fastener assembly in accordance with an aspect of the invention;

FIGS. 4A and 4B show a second embodiment of a fastener assembly in accordance with an aspect of the invention;

FIGS. 5A to 5C show the connection of the fastener assembly of FIGS. 4A and 4B to a metal framing strut;

FIG. 6 shows a third embodiment of a fastener assembly in accordance with an aspect of the invention;

FIGS. 7A to 7E show the connection of the fastener assembly of FIG. 6 to a metal framing strut;

FIGS. 8A and 8B show a fourth embodiment of a fastener assembly in accordance with an aspect of the invention;

FIGS. 9A to 9C show a fifth embodiment of a fastener assembly in accordance with an aspect of the invention;

FIGS. 10A and 10B show a sixth embodiment of a fastener assembly in accordance with an aspect of the invention; and

FIG. 11 is a schematic representation of the onsite installation of prefabricated service modules using the fastener assembly in accordance with the invention.

### DETAILED DESCRIPTION OF THE EMBODIMENTS

There will now be described by way of example a specific mode contemplated by the inventors. In the following description numerous specific details are set forth in order to provide a thorough understanding. It will be apparent however, to one skilled in the art, that the present invention may be practiced without limitation to these specific details. In other instances, well known methods and structures have not been described in detail so as not to unnecessarily obscure the description.

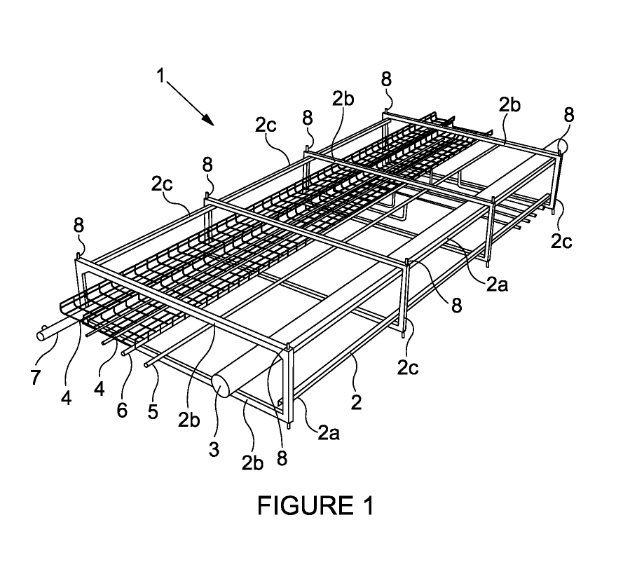

FIG. 1

With reference to FIG. 1, there is shown an example of a prefabricated service module 1.

The service module 1 comprises a support frame 2 in which the components of the service module 1 are housed.

In the example shown, the support frame 2 is constructed from a plurality of elongate members 2a defining the length of the frame 2, cross members 2b defining the width of the frame 2, and side members 2c defining the height of the frame 2.

In the example shown the following components are housed in the support frame 2—a duct 3, cable trays 4 and service pipes 5, 6, 7. It would be understood that the module may have a different arrangement and/or composition of components.

Threaded studs 8 are provided at various locations on the support frame 2 to facilitate connection of the support frame 2 to a support rod (not shown) in order to suspend the support frame 2 from a supporting surface.

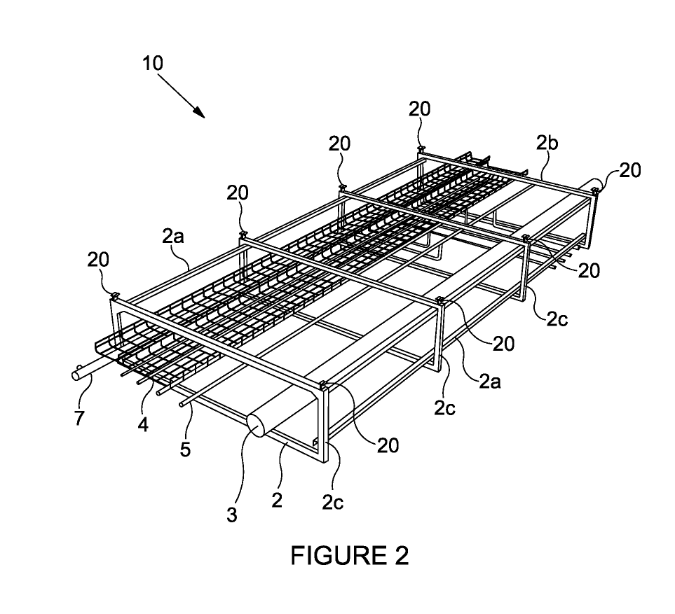

FIG. 2

With reference to FIG. 2 there is shown an embodiment of a prefabricated service module 10 in accordance with an aspect of the invention.

The service module 10 is similar to the one described with reference to FIG. 1, and the same reference numerals have been used to indicate identical/similar features.

The embodiment of the service module 10 in accordance with the invention differs from the previously described example, in that instead of having threaded studs to facilitate installation of the module, the module 10 has a fastener assembly 20 in accordance with an aspect of the invention.

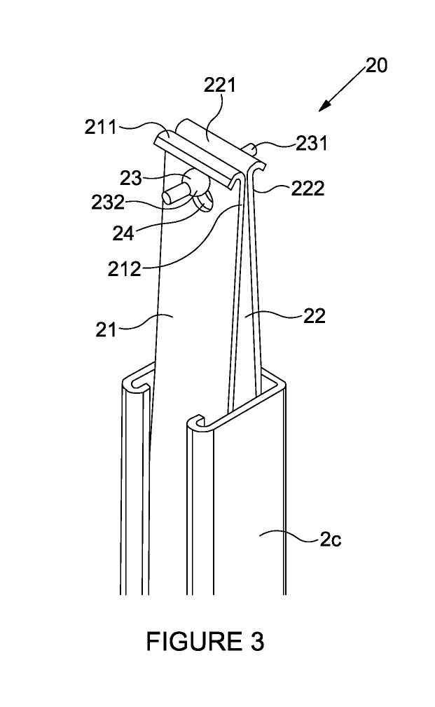

FIG. 3

Referring to FIG. 3, a first embodiment of a fastener assembly 20 in accordance with an aspect of the invention is shown.

The fastener assembly 20 is fixed to a side member 2c of the prefabricated service module.

The fastener assembly 20 includes a first arm 21 having a flange 211 at a first end 212 thereof; a second arm 22 having a flange 221 at a first end thereof 222; and a retainer mechanism 23.

The first and second arms 21, 22 are in the form of a flat plate-like structure and the second arm 22 is arranged parallel and opposite to the first arm 21. The first and second arms 21, 22 are made from a metallic material, although a suitable alternative material may be used.

The flanges 211, 221 of the first and second arms 21, 22 are arranged opposite from one another and extend in a direction away from each other. The flanges 211, 221 each have a width of between 2 mm and 8 mm. The flanges 211, 221 are configured to engage with hooks of a metal framing strut such as a Unistrut® metal framing strut.

In the embodiment shown, the flanges 211, 221 define a hook-like shape, although it would be understood that the flanges may be of a different shape, for example be curved or flat etc.

As will be described in more detail later on, the first end 212 of the first arm 21 and the first end 222 of the second arm 22 are moveable between a first position wherein the first end 212 is spaced apart from the first end 222 of the second arm 22 at a first distance, and a second position wherein said first end 212 is spaced apart from the first end 222 of the second arm 22 at a second distance, the first distance being greater than the second distance. The first ends 212, 222 of the first and second arms 21, 22 are biased towards their respective first positions. In alternative arrangements, only one arm may be moveable between a first and second position.

The retainer mechanism 23 is configured to releasably hold the first ends 212, 222 of the first arm and second arms 21, 22 in the second position.

The retainer mechanism 23 includes a rod 231 and two spaced apart beads 232 mounted on the rod. The beads 232 are positioned on the flange side of the first and second arms 21, 22.

A slot 24 is provided on the first and second arms 21, 22 proximate the first ends 212, 222 thereof for receiving the retainer mechanism 23.

The slots 24 taper in a direction towards the first ends 212, 222 of the first and second arms 21, 22, with the width of the slots proximate the first ends 212, 222 being slightly greater than the diameter of the rod 231, and the maximum width of the slots 24 being less than the diameter of the beads 232. In the embodiment shown, the slots 24 are pear shaped.

The first ends 212, 222 of the first and second arms 21, 22 are held in the second position (as shown in FIG. 3) by the retainer mechanism 23 when the retainer mechanism is positioned proximate the first ends 212, 222 of the first and second arms 21, 22. The retainer mechanism 23 is prevented from moving within the slot 24 on its own volition due to the biasing force biasing the first ends 212, 222 of the first and second arms 21, 22 towards their respective first positions. The biasing force pushes the first and second arms 21, 22 against the beads 232 locking the first ends 212, 222 in position.

Movement of the retainer mechanism 23 in a direction away from the first ends 212, 222 of the first and second arms 21, 22 results in the retainer mechanism 23 dropping down the slot 24 and the beads 232 being partially received in the slots 24 (configuration not shown). This would result in the biasing force moving the first ends 212, 222 of the first and second arms 21, 22 further away from each other.

The second distance will be determined by the spacing between the beads 232, and the first distance will be determined by the size of the beads relative to the maximum width of the slots 24.

The second distance should allow the flanges of the first and second arms when in the second position to be inserted through opening/internal slot in the metal framing strut to which the fastener assembly is to be attached. The second distance in exemplary configurations is between 0 mm and 10 mm.

The first distance is selected based on the size of the metal framing strut the fastener assembly is to be attached to. For example, in relation to a standard 41 mm×41 mm or 41 mm×21 mm metal framing strut, the first distance is preferably between 15 mm and 22 mm.

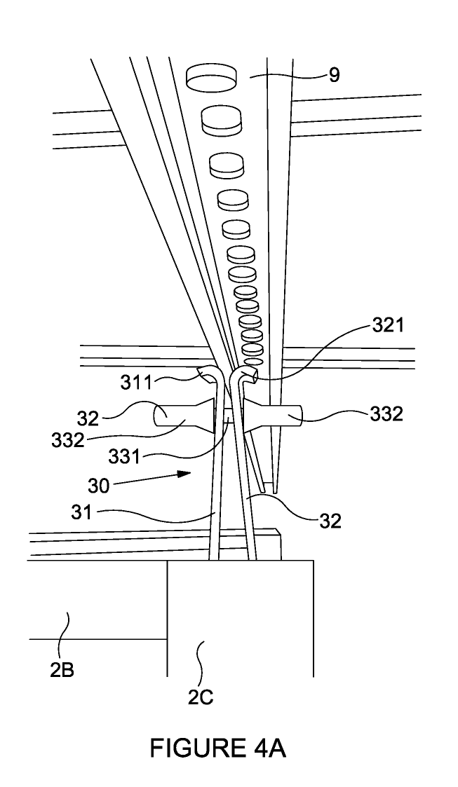

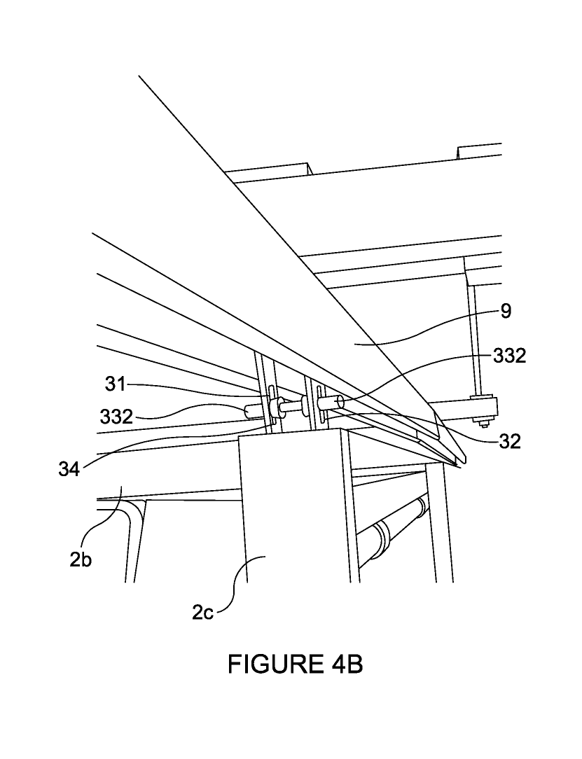

FIGS. 4A and 4B

With reference to FIGS. 4A and 4B, a second embodiment of a fastener assembly 30 in accordance with the invention will now be described.

The second embodiment is similar to the first embodiment and similar features are indicated with the prefix ‘3’ rather than ‘2’.

The second embodiment differs from the first embodiment in that the retainer mechanism 33 instead of having beads mounted on a rod, comprises funnel shaped sections 332 mounted on a rod 331.

The slots 34 in the first and second arms 31, 32 are in the form of an elongated channel and taper in a direction towards the first ends 312, 322 of the first and second arms 31, 32. The width of the slots 34 proximate the first ends being slightly greater than the diameter of the rod 331, and the maximum width of the slots 34 being greater than the maximum diameter of the funnel shaped sections 332.

The length of the retainer mechanism 33 (i.e. distance between opposing ends of the funnel shaped sections 332) is greater than the width of the metal framing strut 9 to which the fastener assembly 30 is to be attached.

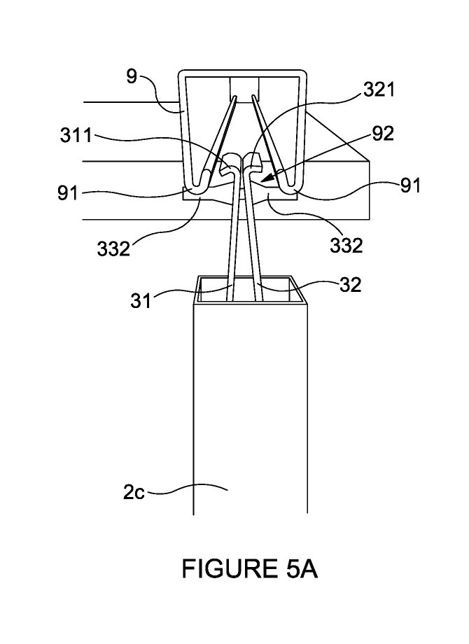

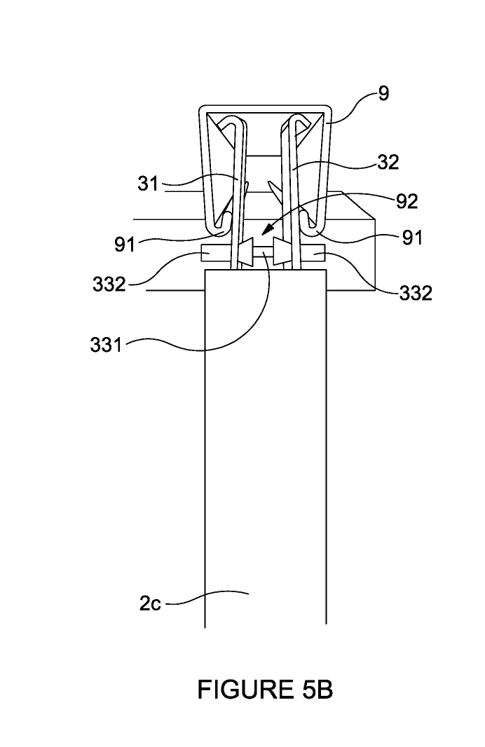

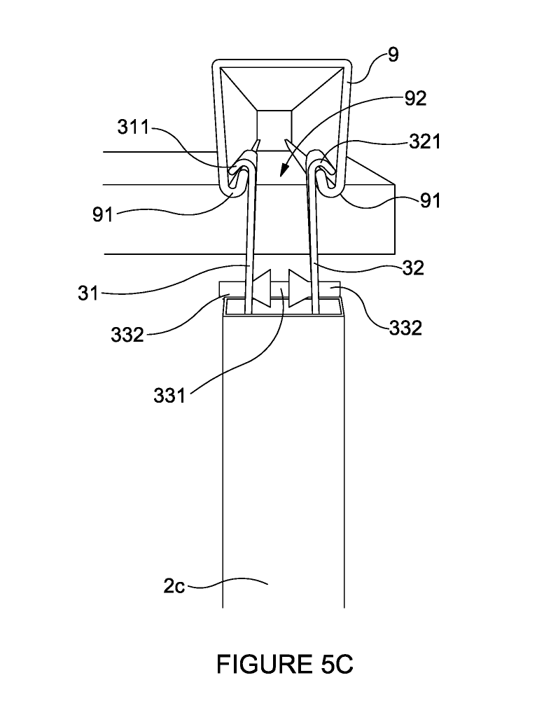

FIGS. 5A to 5C

With reference to FIGS. 5A to 5C, the attachment of the fastener assembly 30 in accordance with the second embodiment to a metal framing strut 9 will now be described. The method of attachment of the fastener assembly 20 in accordance with the first embodiment is similar to the method now being described.

First a user moves the retainer mechanism 33 to hold the first ends 312, 322 of the first and second arms 31, 32 in the second position, if the first ends 312, 322 of the first and second arms 31, 32 are not already in the second position.

The tapered sides of the funnel shaped sections 332 help guide the retainer mechanism 33 in a direction towards the first ends 312, 322 of the first and second arms 31, 32.

The user then locates the flanges 311, 321 of the first and second arms 31, 32 within the opening 92 of the metal framing strut 9. The distance between the first ends of the first and second arms 31, 32 when in the second position is such that the flanges 311, 321 are able to pass through the opening 92 of the metal framing strut 9 (see FIG. 5A).

As the flanges 311, 321 are passed through the opening 92 of the metal framing strut 9, the funnel shaped sections 332 abut the outer surfaces of the hooks 91 of the metal framing strut 9 (see FIG. 5A).

The user then pushes the flanges 311, 321 further into the opening 92 of the metal framing strut 9, which results in the funnel shaped sections 332 being pushed in a direction away from the first ends 312, 322 of the first and second arms 31, 32.

As a result, the retainer mechanism 33 drops down the elongate channel 34, releasing the first ends 312, 322 of the first and second arms 31, 32 from the second position allowing movement of the first and second arms 31, 32 towards the first position (see FIG. 5B).

Lowering of the side member 2c of the prefabricated service module and hence the first and second arms 31, 32, will result in the flanges 311, 321 of the first and second arms 31, 32 engaging with the hooks 91 of the metal framing strut 9 thereby attaching the prefabricated service module to the metal framing strut 9 (see FIG. 5C).

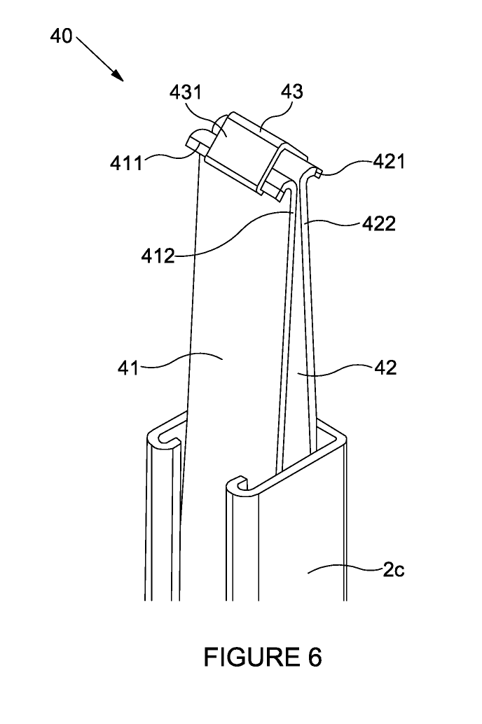

FIG. 6

Referring to FIG. 6, a third embodiment of a fastener assembly 40 in accordance with the invention is shown. Similar features to those of the previously described embodiments are indicated with the prefix ‘4’ rather than ‘2’ or ‘3’.

As in the previously described embodiments, the fastener assembly 40 in accordance with the third embodiment includes a first arm 41 having a flange 411 at a first end 412 thereof; a second arm 42 having a flange 421 at a first end thereof 422; and a retainer mechanism 43.

The fastener assembly 40 differs from the previously described embodiment in that the retainer mechanism 43 is in the form of a clip and that the first and second arms 41, 42 do not have a slot for receiving the retainer mechanism.

The clip 43 is flexible and made from a deformable material, for example a plastics material. The clip 43 may be resiliently deformable or permanently deformable.

In the embodiment shown, the clip 43 has a substantially V-shaped body 431 and comprises an inwardly extending tab 432 (not shown in FIG. 6) at each end thereof. The tabs 432 are configured to engage with a respective flange 411, 421 of the first and second arms 41, 42 in order to hold the first ends 412, 422 of the first and second arms 41, 42 in the second position.

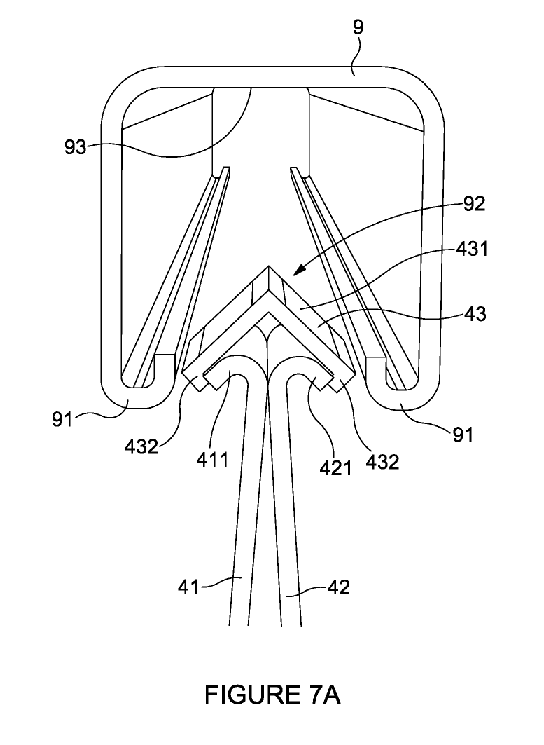

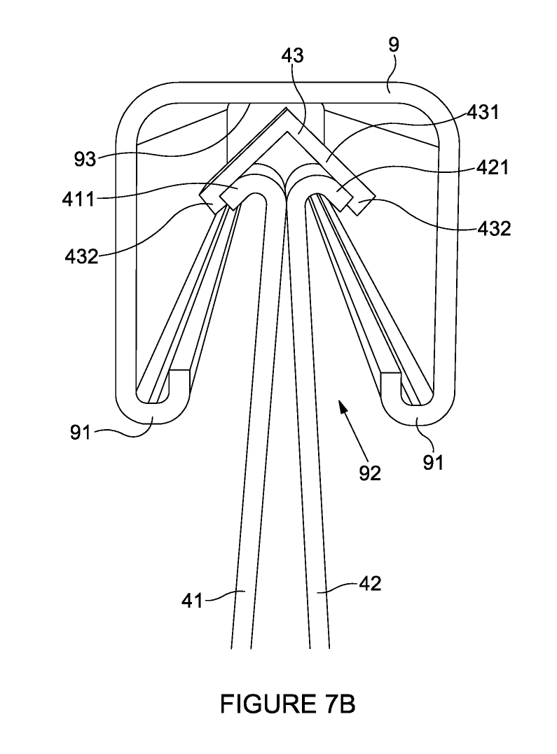

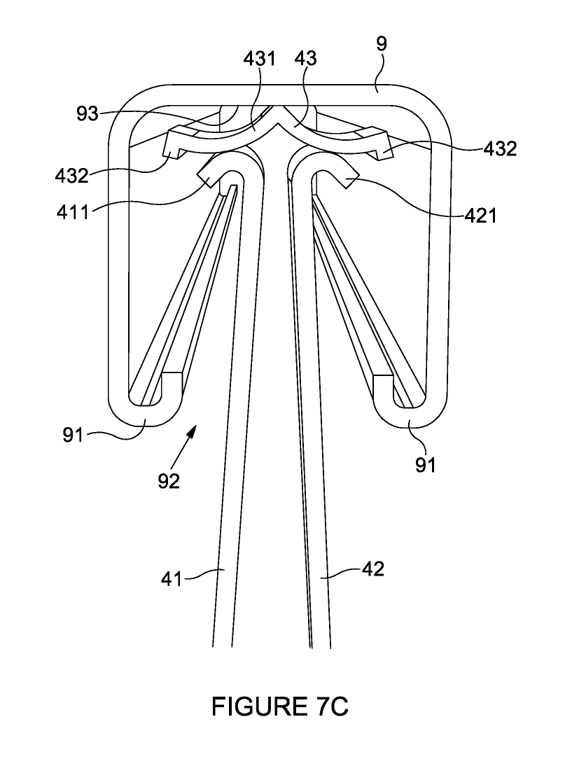

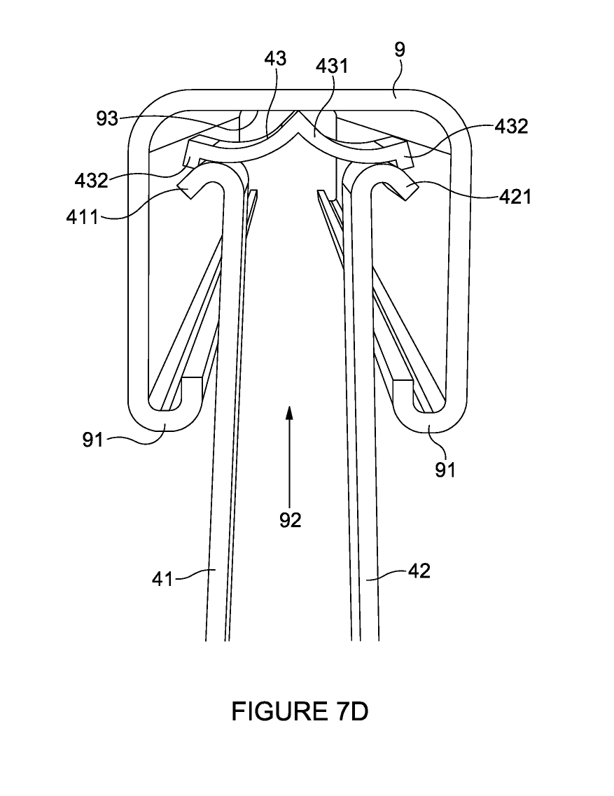

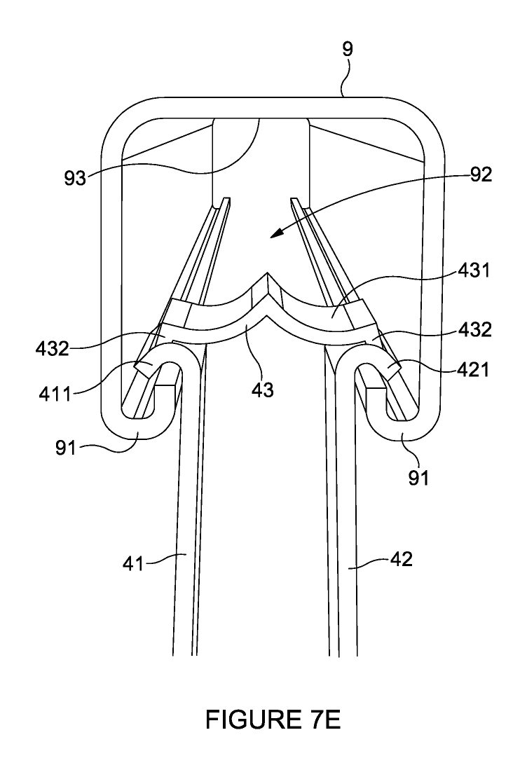

FIGS. 7A to 7E

With reference to FIGS. 7A to 7E, the attachment of the fastener assembly 40 in accordance with the third embodiment to a metal framing strut 9 will now be described.

If the first ends 412, 422 of the first and second arms 41, 42 are not already in the second position, a user first moves the first ends 412, 422 of the first and second arms 41, 42 into the second position and affixes the retainer mechanism 43 to the flanges 411, 421 so as to hold the first ends 412, 422 in the second position.

The user then locates the flanges 411, 421 of the first and second arms 41, 42 within the opening 92 of the metal framing strut 9. The width of the clip 43 when fixed to the flanges 411, 421 of the first and second arms 41, 42 is smaller than the opening 92 of the metal framing strut 9 such that it is able to pass through the opening 92 of the metal framing strut 9 (see FIG. 7A).

The clip 43 is passed through the opening 92 of the metal framing strut 9 until it abuts an inner surface 93 of the metal framing strut 9 opposite the opening (see FIG. 7B).

Further movement of the first and second arms 41, 42 towards the inner surface 93 will result in the deformation of the body 431 of the clip 43 which releases the flanges 411, 412 from engagement with the tabs 432 of the clip 43 (see FIG. 7C).

Once released, the biasing force acting on the first ends 412, 422 of the first and second arms 41, 42 incites the first ends 412, 422 to move in a direction towards the fist position (see FIG. 7D).

Lowering of the first and second arms 41, 42 results in the flanges 411, 421 of the first and second arms 41, 42 engaging with the hooks 91 of the metal framing strut 9 thereby attaching the fastener assembly 40 to the metal framing strut 9 (see FIG. 7E).

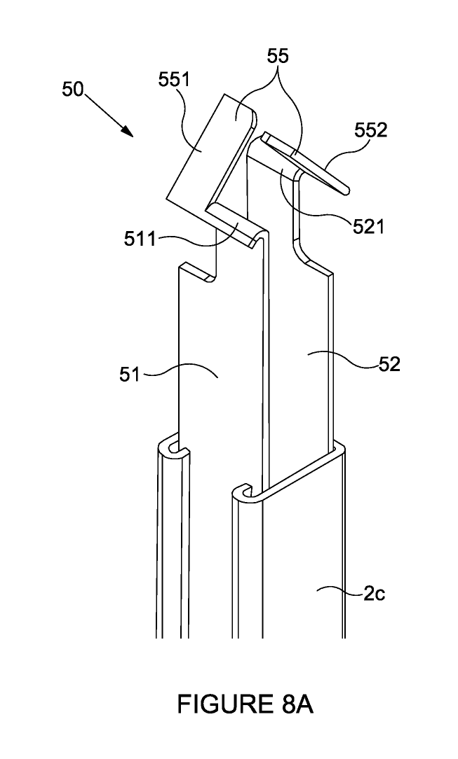

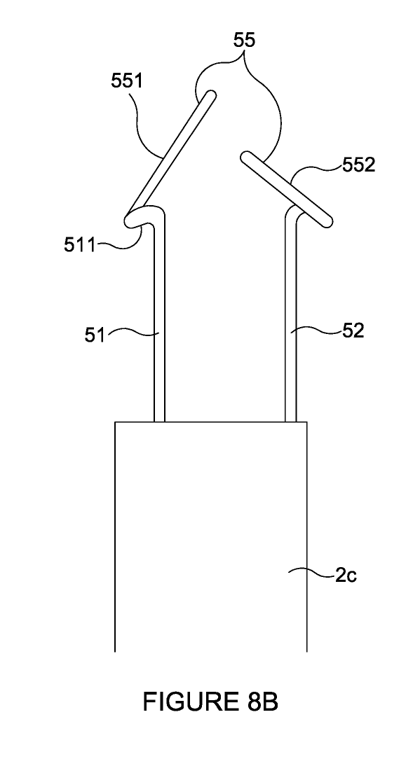

FIGS. 8A and 8B

With reference to FIGS. 8A and 8B, a fastener assembly 50 in accordance with a fourth embodiment of the invention will now be described.

Similar to the previously described embodiments, the fastener assembly 50 includes a first arm 51 having a flange 511 at a first end 512 thereof and a second arm 52 having a flange 521 at a first end 522 thereof.

The fifth embodiment differs from the previously described embodiments in that rather than having a retainer mechanism, it comprises a guide mechanism 55 configured to facilitate movement of the first ends 512, 522 of the first and second arms 51, 52 towards the second position.

The guide mechanism 55 comprises a first guide plate 551 coupled to the flange 511 of the first arm 51 and a second guide plate 552 coupled to the flange 521 of the second arm 52. In the embodiment shown, the first and second guide plates 551, 552 are integrally formed with their respective flanges.

The guide plates 551, 552 are positioned adjacent a respective flange 511, 521 and extend in a direction opposite to the direction of the respective flange 511, 521.

The guide plates 551, 552 are located on opposing ends of the flanges 511, 521 such that their paths cross one another as the first ends 512, 522 of the first and second arms 51,52 move towards the second position.

The guide plates 551, 552 are arranged to engage with the outer surface of a metal framing strut (not shown) and are spaced apart from each other such that a free end of the guide plates 551, 552 is receivable within the opening of the metal framing strut.

In order to attach the fastener assembly 50 to the metal framing strut, a user moves the fastener assembly 50 in a direction towards an inner surface of the metal framing strut.

The guide plates 551, 552 will come into contact with the outer surface of the metal framing strut and start to converge as the further inwards the fastener assembly 50 is moved into the metal framing strut.

As a result, the first ends 511, 521 of the first and second arms 51, 52 are moved towards the second position.

Eventually, the guide plates 551, 552 will be received within the metal framing strut with the guide plates 551, 552 no longer in contact with the outer surface of the metal framing strut.

The biasing force acting on the first and second arms 51, 52 will thus push the first and second arms 51, 52 towards the first position and the first and second arms lowered so that the flanges 511, 521 come into engagement with the hooks of the metal framing strut.

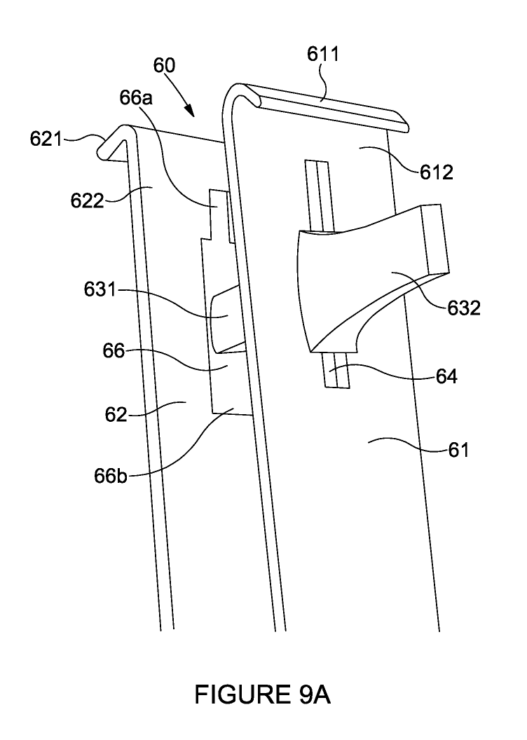

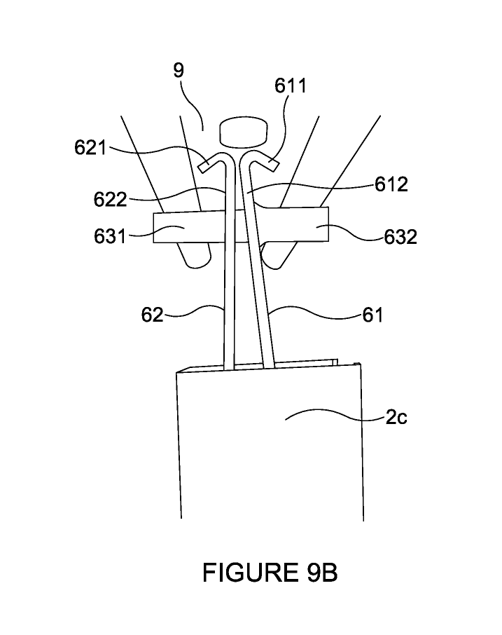

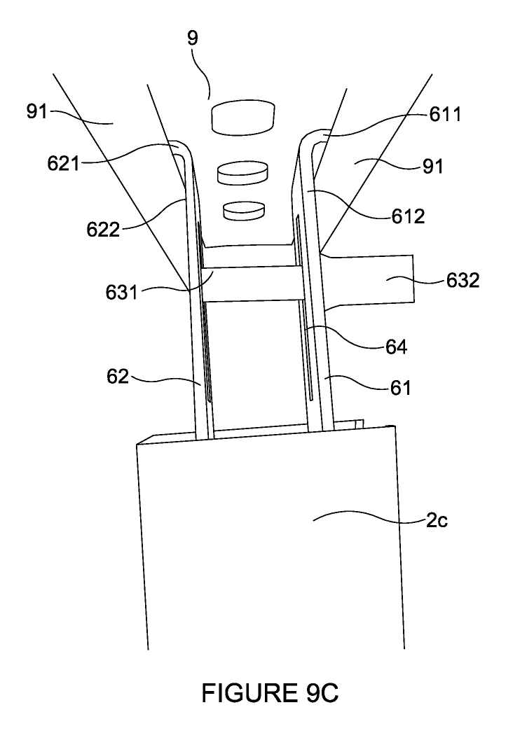

FIGS. 9A, 9B and 9C

With reference to FIGS. 9A to 9C, a fastener assembly 60 in accordance with a fifth embodiment of the invention will now be described.

The fifth embodiment is similar to the second embodiment and similar features are indicated with the prefix ‘6’ rather than ‘3’.

As in the previously described embodiments, the fastener assembly 60 in accordance with the fifth embodiment includes a first arm 61 having a flange 611 at a first end 612 thereof; a second arm 62 having a flange 621 at a first end thereof 622; and a retainer mechanism 63.

The fifth embodiment differs from the first embodiment in that the retainer mechanism 63 instead of having funnel shaped sections mounted on a rod, comprises a stopper 632 mounted on an end of a rod 631.

A slot 64,66 is provided on the first and second arms 61, 62 proximate the first ends 612, 622 thereof for receiving the retainer mechanism 63.

The slot 64 on the first arm 61 is of a width greater than the width of the rod 631 of the retainer mechanism 63 but less than a width of the stopper 632 where the stopper 632 adjoins the rod 631. In the embodiment shown, the width of the stopper 632 where it adjoins the rod 631 corresponds to a maximum width of the stopper 632. It would be understood that the shape of the stopper may be different to the shape illustrated in the drawings wherein the maximum width of the stopper may not be at a location where the stopper 632 adjoins the rod 631.

The slot 66 on the second arm comprises a first slot section 66a proximate the first end 622 of the second arm and a second slot section 66b downstream of the first slot section 66a. The width of the first slot section 66a is less than the width of the stopper 632 where the stopper 632 adjoins the rod 631 and is configure to receive the rod 631 in a snap fit or tightly therein. The width of the second slot section 66b is less than said width of the stopper 632 and configured to receive the rod 631 loosely therein.

The first ends 612, 622 of the first and second arms 621, 622 are held in the second position (as shown in FIG. 9B) by the retainer mechanism 623 when the retainer mechanism 623 is positioned proximate the first ends 612, 622 of the first and second arms 61, 62. The retainer mechanism 63 is prevented from moving within the slots 64,66 on its own volition due to the friction force resulting from the snap/tight fit of the rod 631 with the first slot section 66a and the stopper 632.

Movement of the retainer mechanism 63 in a direction away from the first ends 612, 622 of the first and second arms 61, 62 results in the retainer mechanism 63 dropping down the slots 64, 66 and the rod 631 being moved from the first slot section 66a into the second slot section 66b (configuration not shown). This results in the release of the friction force holding the rod 631 within the second slot 66. Due to the fact that the width of second slot section 66b is configured to loosely hold the rod 631 therein, the biasing force would move the first ends 612, 622 of the first and second arms 61, 62 further away from each other (see FIG. 9C).

The second distance should allow the flanges of the first and second arms when in the second position to be inserted through opening/internal slot in the metal framing strut to which the fastener assembly is to be attached (see FIG. 9B). The second distance in exemplary configurations is between 0 mm and 10 mm.

The first distance is selected based on the size of the metal framing strut the fastener assembly is to be attached to. For example, in relation to a standard 41 mm×41 mm or 41 mm×21 mm metal framing strut, the first distance is preferably between 15 mm and 22 mm.

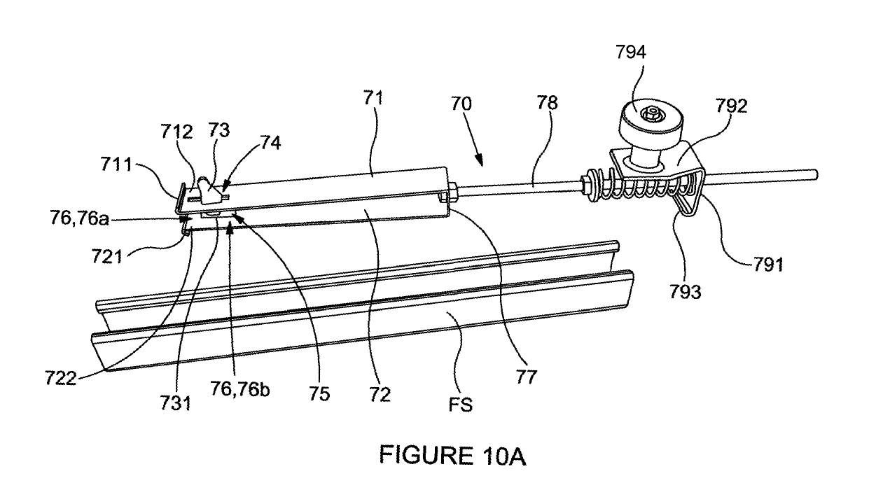

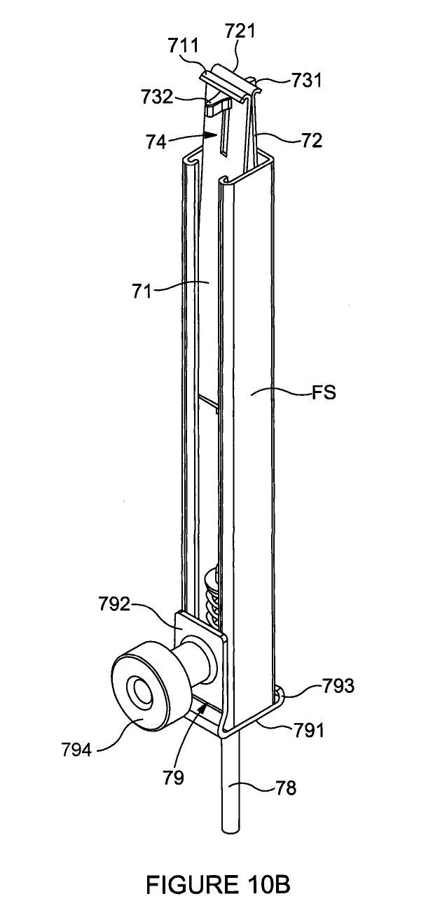

FIGS. 10A and 10B

With reference to FIGS. 10A and 10B, a configuration of a fastener assembly 70 in accordance with a sixth embodiment of the invention will now be described.

As in the previously described embodiments, the fastener assembly 70 in accordance with the sixth embodiment includes a first arm 71 having a flange 711 at a first end 712 thereof and a second arm 72 having a flange 721 at a first end thereof 722.

The fastener assembly 70 may include a retainer mechanism or a guide mechanism similar to those in the previously described embodiments. In the configuration shown, the fastener assembly 70 includes a retainer mechanism 73 that is of the same type as the retainer mechanism of the fifth embodiment.

For convenience, similar features of the sixth embodiment to those of the fifth embodiment are indicated with the prefix ‘7’ rather than ‘6’.

A second end 713 of the first arm 71 is connected to a second end 723 of the second arm 72. In the embodiment shown, the second end of 713 the first arm 71 is connected to the second end 723 of the second arm 72 by a connecting plate 77.

The first and second arms 71, 72 and the connecting plate are shown formed from a single piece of material i.e. integrally formed with each other, although it would be understood that this is not necessarily the case for all configurations.

The fastener assembly 70 includes a threaded stud 78 depending from the connecting plate, and also includes a frame section 79 which is configured to facilitate the coupling of the fastener assembly 70 to a side member 2c of a support frame 2 of a service module 1.

The frame section 79 comprises a base section 791, a front section 792 extending upwardly from the base section 791, and a flange section 793 extending in the same direction as the front section 792 from an opposite edge of the base section 791.

The frame section 79 is mounted on the threaded stud 78 such that a portion of said threaded stud 78 is located between the front section 792 and the flange section 793 of the frame section 79. In the configuration shown, the threaded stud 78 is positioned centrally on the base section 791.

The length of the threaded stud 78 above the base section 791 can be adjusted by rotation of the threaded stud 78. This is advantageous as, in use, it allows for fine adjustment of the alignment of the components of a service module relative to the components of an adjacent service module in order to connect the components of the adjacent service modules together.

The fastener assembly 70 is receivable within a metal framing strut FS such as the one used for fabricating the side members of the support frame 2 (see FIG. 10B).

A bolt (not shown) and associated retaining plate (not shown) is located on a back face of the front section 792 to facilitate the coupling of the frame section 79 and hence the fastener assembly 9, to the side member 2c of the support frame 2.

In the embodiment shown, a mounting pin 794 is located on a front face 7921 of the front section 792 to facilitate the lifting of a service module to which the fastener assembly is attached. However, it would be understood that the mounting pin 794 may be omitted.

It would be understood that a configuration of the fastener assembly in accordance with the invention may have a second end of the first arm connected to a second end of the second arm by a connecting plate as described above, but omitting a frame section and/or threaded stud.

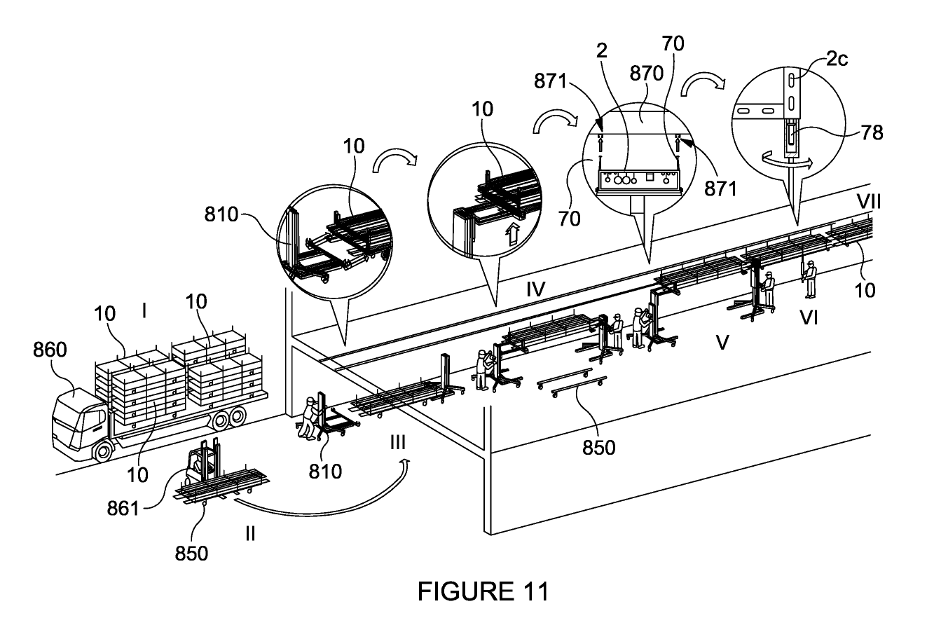

FIG. 11

With reference to FIG. 11, the on-site installation of prefabricated service modules using the fastener assembly in accordance with the sixth embodiment of the invention will now be described.

The service modules 10 are transported onto a construction site via suitable means, for example on the back of an articulated lorry 860 (step I).

Once on-site, the service modules 10 may be unloaded from the articulated lorry 860 and stored in a storage location on-site or may be kept on the back of the articulated lorry to be unloaded as and when needed. The arrangement shown in FIG. 11 is one wherein the service modules are kept on the back of the articulated lorry 860.

A service module 10 to be installed is first unloaded from the articulated lorry 860 using suitable means as known in the art, for example by means of a forklift truck 861 as shown (step II). The service modules 10 are provided on dollies on the back of the articulated lorry 860 and the dolly carrying the service module 10 is lifted off the back of the articulated lorry 860 by the forklift truck 861.

Fastener assemblies 70, if not already attached to side members 2c of the service module(s), are attached to opposing side members 2c of the service module(s) at the points where the service module is to be suspended from the support surface.

The forklift truck 861 may be used to transport the service module 10 to the location where it is to be loaded onto suitable material lifts 810 or may be moved to the desired location by means of the dolly 850. Once at the required location, corresponding hooks on the material lifts 810 are moved into engagement with the mounting pins 794 on the fastener assembly 70 (step III).

Once the hooks and mounting pins 794 are engaged with each other, the service module is lifted off the dolly (step IV).

The support surface 870 from which the service module is to be suspended is provided with parallel support rails 871 formed from metal framing struts, for example a Unistrut® metal framing strut.

The service module 10 is moved to the location where it is to be installed and then lifted so that the flanges 711, 721 of the fastener assemblies 70 engage with hooks of a corresponding metal framing strut of the support rails 871 (step V).

Once the flanges 711, 721 of the fastener assemblies 70 are engaged with the support rails 871, the material lifts are removed by disengaging the respective hooks from the mounting pins 794.

The service module 10 is secured in place by fastener assemblies 70 on the support rails 871.

Alignment of the components of the service module with the components of an adjacent service module is accomplished by loosening or tightening each of the threaded studs 78 of the fastener assemblies 70 (step VI).

The components housed in the support frame service of the secured service module are then connected to the corresponding components in an adjoining service module (step VII).

Accordingly, the final adjust and lock during installation of the service module can be done from floor level.

Where technically appropriate, embodiments of the invention may be combined.

Unless not technically feasible, features and/or characteristics of features of one embodiment of the invention may be incorporated into another embodiment of the invention.

While the invention has been described with reference to facilitating the positioning and/or installation prefabricated service modules, it may also be utilized in the suspension of heavy objects normally suspended by means of a support rod as ducting, integrated service modules etc.

Embodiments are described herein as comprising certain features/elements. The disclosure also extends to separate embodiments consisting or consisting essentially of said features/elements.

In the context of this specification “comprising” is to be interpreted as “including”.

While the above mentioned embodiments have been described with reference to certain dimensional ranges, it would be understood that the invention is not limited thereto and that the dimensions of certain features of the invention would be dependent on their specific application.

Aspects of the disclosure comprising certain elements are also intended to extend to alternative embodiments “consisting” or “consisting essentially” of the relevant elements.

Technical references such as patents and applications are incorporated herein by reference.

Any embodiments specifically and explicitly recited herein may form the basis of a disclaimer either alone or in combination with one or more further embodiments.

1. A fastener assembly for a prefabricated service module comprising:
a first arm having a first arm flange at a first end of the first arm, the first end of the first arm being moveable between a first position and a second position;
a second arm having a second arm flange at a first end of the second arm, the second arm being arranged parallel and opposite to the first arm, the second arm flange being arranged opposite to the first arm flange, the second arm flange extending in a direction away from the first arm flange, the first position being located where the first end of the first arm is spaced apart from the first end of the second arm at a first distance, the second position being located where the first end of the first arm is spaced apart from the first end of the second arm at a second distance, the first distance being greater than the second distance; and
a retainer mechanism that is configured to hold the first end of the first arm in the second position, the retainer mechanism being further configured to release the first end of the first arm from the second position upon receipt of a displacement force resulting from the retainer mechanism being pressed into contact with a section of a metal framing strut to which the fastener assembly is to be attached.

2. The fastener assembly of claim 1, wherein the first end of the second arm is moveable between a third position and a fourth position, the third position being located where the first end of the second arm is spaced apart from the first end of the first arm at the first distance, the fourth position being located where the first end of the second arm is spaced apart from the first end of the first arm at the second distance.

3. The fastener assembly of claim 1, wherein the first end of the first arm and/or the first end of the second arm is biased towards the first position.

4. The fastener assembly of claim 1, wherein the first distance is greater than 14 mm.

5. The fastener assembly of claim 1, wherein the second distance is between 0 mm and 10 mm.

6. The fastener assembly of claim 1, wherein the flange of the first arm and/or the second arm has a width between 2 mm and 8 mm.

7. The fastener assembly of claim 1, wherein the first arm and/or the second arm is a flat plate.

8. The fastener assembly of claim 1, wherein the first arm flange and/or the second arm flange is straight.

9. The fastener assembly of claim 1, wherein the first arm flange and/or the second arm flange is curved.

10. The fastener assembly of claim 1, wherein the flange of the first arm flange and/or the second arm flange defines a hook.

11. The fastener assembly of claim 1, wherein the retainer mechanism comprises a rod and two spaced apart beads mounted on the rod, the first arm comprising a first slot positioned on the first arm, the first slot being proximate to the first end of the first arm, the second arm comprising a second slot positioned on the second arm, the second slot being proximate to the first end of the second arm, the first slot and the second slot receiving the retained mechanism.

12. The fastener assembly of claim 11, wherein the first slot and the second slot taper in a direction towards the first end of the first arm and the second end of the second arm, a first width of the first slot and a second width of the second slot each being slightly greater than a diameter of the rod, a the maximum width of each of the first slot and the second slot being less than a diameter of the two spaced apart beads.

13. The fastener assembly of claim 12, wherein the first slot is pear shaped and the second slot is pear shaped.

14. The fastener assembly of claim 1, wherein the retainer mechanism comprises a rod and two spaced apart funnel shaped sections mounted on the rod, the first arm comprising a first slot positioned on the first arm, the first slot being proximate to the first end of the first arm, the second arm comprising a second slot positioned on the second arm, the second slot being proximate to the first end of the second arm, the first slot and the second slot.

15. The fastener assembly of claim 14, wherein each of the first slot and the second slot has a shape of an elongated channel, the first slot and the second slot tapering toward the first end of the first arm and the first end of the second arm, each of a first width of a first slot and a second width of a second slot being slightly greater than a diameter of the rod, a maximum width of the first a lot and the second slot being greater than a maximum diameter of the funnel shaped sections.

16. The fastener assembly of claim 1, wherein the retainer mechanism comprises a clip.

17. The fastener assembly of claim 16, wherein the clip is flexible and made from a deformable material.

18. The fastener assembly of claim 17, wherein the clip is resiliently deformable.

19. The fastener assembly of claim 16, wherein the clip comprises a substantially V-shaped body and an inwardly extending tab at each end of the V-shaped body, the inwardly extending tab configured to engage with a corresponding flange of the first arm or the second arm.

20. The fastener assembly of claim 1, wherein the retainer mechanism comprises a rod and a stopper mounted on an end of the rod, the first arm comprising a first slot positioned on the first arm, the first slot being proximate to the first end of the first arm, the second arm comprising a second slot positioned on the second arm, the second slot being proximate to the first end of the second arm, the first slot and the second slot receiving the retainer mechanism.

21. The fastener assembly of claim 20, wherein the second slot comprises a first slot section proximate the first end of the second arm and a second slot section downstream of the first slot section, wherein a width of the first slot section is less than a width of the stopper and is configured to receive the rod in a snap fit or tightly therein, and a width of the second slot section is less than said width of the stopper and is configured to receive the rod loosely therein.

22. A fastener assembly for a prefabricated service module comprising:
a first arm having a first arm flange at a first end of the first arm, the first end of the first arm being moveable between a first position and a second position;
a second arm having a second arm flange at a first end of the second arm, the second arm flange being arranged opposite to the first arm flange such that the second arm flange faces away from the first arm flange, the first position being located where the first end of the first arm is spaced apart from the first end of the second arm at a first distance, the second position being located where the first end of the first arm is spaced apart from the first end of the second arm at a second distance, the first distance being greater than the second distance;
a guide mechanism that facilitates movement of the first end of the first arm from the first position to the second position.

23. The fastener assembly of claim 22, wherein the guide mechanism comprises a first guide plate coupled to the the first arm flange and a second guide plate coupled to the second arm flange.

24. The fastener assembly of claim 23, wherein the first guide plate and the second guide plate are integrally formed with a corresponding flange.

25. The fastener assembly of claim 23, wherein the first guide plate and the second guide plate are positioned adjacent a corresponding flange and extend in a direction opposite to the direction of the corresponding flange.

26. The fastener assembly of claim 23, wherein the first guide plate and the second guide plate are located on opposing ends of the first arm flange and the second arm flange, respectively, the first guide plate and the second guide plate being configured to cross one another as the first end of the first arm and the first end of the second arm move towards the second position.

27. The fastener assembly of claim 1, wherein a second end of the first arm is connected to a second end of the second arm.

28. The fastener assembly of claim 27, wherein the second end of the first arm is connected to the second end of the second arm by a connecting plate.

29. The fastener assembly of claim 28, wherein the first arm and the second arm are integrally formed with the connecting plate.

30. The fastener assembly of claim 28, further comprising a threaded stud depending from the connecting plate.

31. The fastener assembly of claim 30, further comprising a frame section configured to facilitate the coupling of the fastener assembly to a side member of a support frame of a service module.

32. The fastener assembly of claim 31, wherein the frame section comprises a base section, a front section extending upwardly from the base section, and a flange section extending in the same direction as the front section from an opposite edge of the base section.

33. The fastener assembly of claim 32, wherein the frame section is mounted on the threaded stud such that a portion of the threaded stud is located between the front section and the flange section of the frame section.

34. The fastener assembly of claim 33, wherein the threaded stud is positioned centrally on the base section.

35. (canceled)

36. (canceled)

37. A prefabricated service module comprising:
a fastener assembly comprising a first arm having a first arm flange at a first end of the first arm, a second arm having a second arm flange at a first end of the second arm, and a retainer mechanism that is configured to hold the first end of the first arm in the second position, the first end of the first arm being moveable between a first position and a second position, the second arm being arranged parallel and opposite to the first arm, the second arm flange being arranged opposite to the first arm flange, the second arm flange extending in a direction away from the first arm flange, the first position being located where the first end of the first arm is spaced apart from the first end of the second arm at a first distance, the second position being located where the first end of the first arm is spaced apart from the first end of the second arm at a second distance, the first distance being greater than the second distance, the retainer mechanism being further configured to release the first end of the first arm from the second position upon receipt of a displacement force resulting from the retainer mechanism being pressed into contact with a section of a metal framing strut to which the fastener assembly is to be attached.

38. The prefabricated service module of claim 37, wherein a plurality of framing struts is installed at a support surface such that each of the plurality of struts is positioned at a distance away from each other, the fastener assembly being connected to the plurality of framing struts.
